(19) United States
(12) Patent Application Publication
(10) Pub. No.: US 2017/0074378 A1
(43) Pub. Date: Mar. 16, 2017

(54) PROPULSION DEVICE FOR A VEHICLE, ESPECIALLY AN ELECTRIC OR HYBRID VEHICLE

(71) Applicant: SIEMENS AKTIENGESELLSCHAFT, Munchen (DE)

(72) Inventor: Eckhard Kirchner, Erlangen (DE)

(73) Assignee: SIEMENS AKTIENGESELLSCHAFT, Munchen (DE)

(21) Appl. No.: 15/264,112

(22) Filed: Sep. 13, 2016

(30) Foreign Application Priority Data
Sep. 14, 2015 (DE) 10 2015 217 521.9

(51) Int. Cl. F16H 37/08; F16H 1/28; F16H 3/54; B60K 1/04

(52) U.S. Cl. CPC F16H 37/0813; B60K 1/04; F16H 1/28; F16H 3/54; F16H 2200/0034; F16H 2200/2005

(57) ABSTRACT

A propulsion device for a vehicle includes a differential gear, which is driven by the electric machine via a planetary gear and operatively connected to an axle on the vehicle, with the planetary gear including at least three rotatable gear elements. A switching device is switchable by an actuator between a first switch position, in which one gear element is secured against a rotation about the axis of rotation, and a second switch position, in which the one gear element is connected by the switching device to another gear element in a torsion-proof manner. A parking brake including at least one parking brake element is movable by the actuator between a park position, in which the vehicle is prevented from rolling away, and at least one release position.

### CROSS-REFERENCES TO RELATED APPLICATIONS

This application claims the priority of German Patent Application, Serial No. Serial No. 102015217521.9, filed Sep. 14, 2015, pursuant to 35 U.S.C. 119(a)-(d), the disclosure of which is incorporated herein by reference in its entirety as if fully set forth herein.

### BACKGROUND OF THE INVENTION

The present invention relates to a propulsion device for a vehicle, especially an electric or hybrid vehicle.

The following discussion of related art is provided to assist the reader in understanding the advantages of the invention, and is not to be construed as an admission that this related art is prior art to this invention.

Vehicles that are embodied as electric or hybrid vehicles are known in the art. Such a vehicle includes at least one electric machine to propel the vehicle. In other words, the electric machine is embodied for driving the vehicle, so that the electric machine is also called a traction machine.

In order to drive the vehicle, the electric machine is supplied with electric current. For this purpose, the vehicle has at least one electric energy store, especially in the form of a battery, where electric current or electric energy can be stored in the electric energy store. In this case, the electric machine can be supplied with the electric current stored in the electric energy store, in order to drive the vehicle electrically, especially purely electrically. Purely electric drive is to be understood as the vehicle moving purely under electric power, such that the vehicle is driven exclusively with the aid of electric energy in the absence of a combustion engine.

Usually the vehicle also includes a gear unit that is driven by the electric machine, so that the vehicle can be driven via the gear unit by the electric machine. In this case, the vehicle has ground contact elements, especially in the form of wheels. While on the move, the vehicle rolls on a road via the ground contact elements. To drive the vehicle, the wheels are driven by the electric machine via the gear unit.

Such a vehicle, which includes an electric machine for driving the vehicle and a battery for supplying the electric machine with electric current, is also called a battery-electric vehicle (BEV). With battery-electric vehicles, the performance, and thus the size, meaning the outer dimensions, of the electric machine, as well as the gear ratio of the gear unit is usually determined by requirements for initial acceleration. The vehicle can be accelerated by virtue of the electric machine via the gear unit, especially as part of a process of the vehicle starting from rest. Usually the possible top speed of the vehicle, as well as the capability to accelerate at high speeds suffer as a rule from being restricted to a single-gear gear unit, which is to be understood as a gear unit with precisely one gear.

It would be desirable and advantageous to provide an improved propulsion device for a vehicle to obviate prior art shortcomings and to realize high initial acceleration and high top speed in a space-saving and cost-effective way.

### SUMMARY OF THE INVENTION

According to one aspect of the present invention, a propulsion device includes an electric machine, a differential gear driven by the electric machine and operatively connected to an axle on the vehicle, with ground contact elements of the axle being driven by the electric machine via the differential gear, a planetary gear via which the differential gear is driven by the electric machine, the planetary gear comprising at least three gear elements that are rotatable about an axis of rotation, with one of the at least three gear elements being configured as a planet carrier, and at least one planet gearwheel which is different from the at least three gear elements, the planet gearwheel being rotatably supported on one of the at least three gear elements and in engagement with the other ones of the at least three gear elements via respective sets of teeth, a first one of the at least three gear elements being driven by the electric machine, and a second one of the at least three gear elements being driven by the electric machine via the first of the at least three gear elements and coupled to the differential gear, a switching device including at least one switching element and switchable between a first switch position, in which a third one of the at least three gear elements is secured against a rotation about the axis of rotation, and at least one second switch position in which the third one of the at least three gear elements is connected by the switching device to the first one of the at least three gear elements in a torsion-proof manner, an actuator configured to move the at least one switching element of the switching device between the first and second switch positions, and a parking brake including at least one parking brake element, the parking brake being movable by the actuator between a park position, in which the vehicle is prevented from rolling away, and at least one release position.

In accordance with the present invention, the propulsion device for a vehicle, especially an electric or hybrid vehicle, includes a differential gear, which is driven by an electric machine and connected to an axle on the vehicle. Ground contact elements of the axle are driven by the electric machine. The ground contact elements may comprise wheels, such that the vehicle, embodied for example as an automobile, rolls when traveling on a road. The vehicle is driven by the electric machine via the wheels.

The differential gear is also referred to as a differential transmission or differential, and allows the wheels to rotate at different speeds, when the vehicle is negotiating a curve, so that for example, the wheel on the outside of the curve can rotate faster than the wheel on the inside of the curve.

The planetary gear of the propulsion device has three gear elements that are rotated about an axis of rotation. One is embodied as the planet carrier of the planetary gear. The planetary gear further includes at least one planet gearwheel differing from the gear elements, which is supported rotationally on a one gear element, i.e. on the planet carrier, and is in engagement with the other gear elements via respective sets of teeth.

In this case, a first of the gear elements is driven by the electric machine. Furthermore, a second of the gear elements can be driven via the first gear element by the electric machine and is coupled to the differential gear, such that the differential gear is driven by the electric machine via the second gear element and the first gear element. Overall, the vehicle can thus be driven by the electric machine via the differential gear, the second gear element and the first gear element.

The switching device of the propulsion device is switched or adjusted between at least two switch positions. In a first switch position of the switching device, the third gear element is secured from rotating about the axis of rotation via the switching device. For example, the propulsion device, especially the planetary gear has a housing. The gear elements are rotated about the axis of rotation relative to the housing. In the first switch position of the switching device, the third gear element is fixed via the switching device on the housing, so that the third gear element cannot rotate about the axis of rotation relative to the housing.

In the second switch position of the switching device, the third gear element is connected in a torsion-proof manner to the first gear element via the switching device, so that when the first gear element is driven by the electric machine. The first gear element and the third gear element orbit together as a block, and in doing so, rotate about the axis of rotation relative to the housing.

The second gear element is thus a take-off of the planetary gear and the first gear element is a drive of the planetary gear. The planetary gear is driven via the drive from the electric machine and provides torques via the take-off, which are transmitted to the differential gear, so that the differential gear can be driven via the take-off, and thus by the torques provided via the take-off.

The fact that the switching device is provided, and can be switched between the switch positions, means that the planetary gear is switchable, so that both an especially high initial acceleration as well as an especially high top speed of the vehicle can be realized by means of the propulsion device. The initial acceleration is to be understood as an acceleration able to be brought about by means of the propulsion device, with which the vehicle can be accelerated from rest as part of a starting process. The top speed is the maximum realizable traveling speed of the vehicle. The high initial acceleration and the high top speed can be realized by means of the propulsion device in an especially space-saving and cost-effective way, since as a result of the fact that the planetary gear is switchable, so that for example at least two different gear ratios are able to be set, the external dimensions of the propulsion device and in particular of the electric machine can be kept especially small.

Advantageously, the number of parts and thus the weight, the installation space required and the costs of the propulsion device can be kept low, since only the switching device is provided and required in order to switch the planetary gear, and thus to obtain a high initial acceleration and a high top speed.

The electric machine of the propulsion device can be embodied as a traction machine for driving the vehicle. The electric machine can be operated, for example, in a motor mode, and thus as an electric motor. The vehicle can be driven via the planetary gear and the differential gear by the electric machine in the motor mode. It is further conceivable for the electric machine to be able to be operated in a generator mode and thus as a generator. In this generator mode the electric machine is driven for example via the differential gear and the planetary gear by the moving vehicle and thus by means of kinetic energy of the vehicle, wherein, in the generator mode, at least a part of the kinetic energy of the vehicle is converted into electric energy by means of the electric machine. Through this the vehicle is slowed down or braked for example. The electric machine provides the electric energy for example, so that at least one electric load can be supplied with the electric energy. As an alternative or in addition it is conceivable to store the electric energy in an electric storage device, in particular in a battery. In this case there can be provision for the propulsion device to include at least one such storage device.

According to another advantageous feature of the present invention, an actuator is provided, by means of which at least one switching element of the switching device is able to be moved between the switch positions. In the first switch position, the third gear element is secured by the switching element against a rotation about the axis of rotation, wherein the third gear element in the second switch position is connected to the first gear element in a torsion-proof manner. By means of the actuator automatic or automated or partly-automatic or partly-automated switching of the switching device, in particular of the switching element, can be realized, so that for example an especially advantageous transition from the first switch position into the second switch position and vice versa can be realized. In particular it is possible, after the startup process, to move the switching element by means of the actuator from the first switch position into the second switch position or vice versa, in order to realize an especially advantageous operation of the propulsion device and thus of the vehicle as a whole thereby.

According to another advantageous feature of the present invention, a parking brake with at least one parking brake element is provided, which is moved between a park position to prevent the vehicle rolling away and at least one released position. The propulsion device, in this case, includes at least one take-off shaft. The vehicle is driven by the electric machine. This take-off shaft, for example, involves one of the gear elements, but also a different shaft of the propulsion device from the gear elements. The take-off shaft is rotated about a second axis of rotation, in particular, relative to the housing. The second axis of rotation can be spaced away from the aforementioned first axis of rotation of the gear elements, or can coincide with the first axis of rotation. In the park position, the parking brake element acts to make a form fit together with the take-off shaft, such that the take-off shaft is secured via the brake element located in the park position from a rotation about the second axis of rotation. This advantageously enables the vehicle, when it is parked on an incline for example, not to roll away as a result of gravity, since the take-off shaft, and thus the ground contact elements, which are driven via the take-off shaft, cannot rotate.

In the release position, however, the parking brake element releases the take-off shaft, and thus the ground contact elements (wheels) of the vehicle, so that the take-off shaft and the ground contact elements can rotate. As a result, the vehicle is driven by the electric machine.

In order to keep the installation space required for the propulsion device small, there is provision for the parking brake element to be moved via the actuator. This means that the actuator is embodied to move the parking brake element from the park position into the release position and/or from the release position into the park position. This enables a separate actuator for actuating or moving the parking brake element. Consequently, the number of parts, the weight, the costs and the installation space required for the propulsion device can be kept low. In other words, there is provision for the parking brake element and the switching element to be adjusted or moved via the same actuator.

According to another advantageous feature of the present invention, the first one of the at least three gear elements can be configured as a hollow gearwheel, the second one of the at least three gear elements can be configured as a planet carrier, and the third one of the at least three gear elements can be configured as a sun gearwheel of the planetary gear. Thus the planet carrier represents the take-off of the planetary gear, wherein the hollow gearwheel represents the drive of the planetary gear. The sun gearwheel, as required, can be fixed to the housing by means of the switching device or can be secured against a rotation about the axis of rotation but also connected in a torsion-proof manner to the hollow gearwheel, so that both an especially high initial acceleration and also an especially high top speed are able to be realized in a cost-effective and space-saving manner.

According to another advantageous feature of the present invention, the actuator can be an electromechanical actuator, a hydraulic actuator, an electro-hydraulic actuator, or an electromagnetic actuator. As a result costs, weight and installation space required for the propulsion device can be kept low. This also enables short switching times of the switching device, in particular of the switching element, to be obtained.

According to another advantageous feature of the present invention, the planetary gear can have a stationary gear ratio ranging from 1.5 to 4. In other words the mathematical amount of the stationary gear ratio of the planetary gear lies in a range from 1.5 to 4, wherein the stationary gear ratio is usually designated i₀. For example the stationary gear ratio or its value lies in a range of −4 to −1.5.

According to another advantageous feature of the present invention, the planetary gear in the second switch position can have a gear ratio which is smaller than a gear ratio in the first switch position. A rotational speed, at which, the first gear element rotates about the axis of rotation, when the first gear element is driven by the electric machine, is also referred to as the rotational drive speed, since the first gear element forms the drive of the planetary gear. Since the second gear element forms the take-off of the planetary gear, a rotational speed, at which, the second gear element rotates about the axis of rotation, when the second gear element is driven via the first gear element by the electric machine, is referred as the rotational take-off speed.

Since the planetary gear in the second switch position advantageously has now a smaller gear ratio than in the first switch position, the rotational take-off speed is smaller in the first switch position than in the second switch position when the rotational drive speed remains the same, so that the first switch position is embodied for example as a slow drive stage and the second switch position as a fast drive stage. Thus, by means of the first switch position an especially high initial acceleration can be realized, wherein the provision of the second switch position enables an especially high top speed of the vehicle can be realized.

According to another advantageous feature of the present invention, the planetary gear can have a gear step of at least 1.3, when the switching device switches from the first switch position to the second switch position. The gear step is to be understood in particular as the quotient of the gear ratio of the planetary gear in the first switch position and the gear ratio of the planetary gear in the second switch position. In the first switch position, the vehicle can thus be moved or driven in a so-called low speed range, wherein, in the second switch position, the vehicle can thus be moved or driven in a so-called high speed range, wherein the high speed range is greater than the low speed range. Thus, provision is made for the gear step to amount to at least 1.3 during switching from the low to the high speed range.

According to another advantageous feature of the present invention, the gear step can range from 1.3 to 1.6. As a result, a high initial acceleration and a high top speed are realized. This is especially advantageous for an electric vehicle, which can be propelled purely electrically, i.e. not by a combustion motor. With a hybrid vehicle the gear step can be greater than 1.6, wherein a hybrid vehicle differs from an electric vehicle in that the hybrid vehicle, by contrast with the hybrid vehicle, has an internal combustion engine for propelling the hybrid vehicle.

According to another advantageous feature of the present invention, at least one rotational speed sensor can be provided to detect a rotational speed of one of the at least three gear elements, in particular, of the second one of the gear elements. By detection of the rotational speed it is possible for example to move or to switch the switching element via the actuator depending on the rotational speed detected by means of the rotational speed sensor, so that especially advantageous switching processes of the propulsion device can be realized.

According to another advantageous feature of the present invention, the third one of the at least three gear elements can be secured via the switching device in the first switch position by a form fit against a rotation about the axis of rotation and can be connected in the second switch position by a form fit to the first one of the at least three gear elements in a torsion-proof manner. This enables an especially high efficiency of the propulsion device to be realized.

According to another advantageous feature of the present invention, the third one of the at least three gear elements can be secured via the switching device in the first switch position by a friction fit against a rotation about the axis of rotation and connected in the second switch position by a friction fit to the first one of the at least three gear elements in a torsion-proof manner This enables especially convenient switching processes to be realized.

According to another aspect of the present invention, a vehicle, in particular, an electric or hybrid vehicle, includes at least one electric machine embodied as a traction machine for driving the vehicle, and a propulsion device, as set forth above. Advantages and embodiments of the inventive propulsion device are to be seen as advantages and embodiments of the inventive vehicle, and vice versa.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first embodiment of a propulsion device according to the present invention;

FIG. 2 is a schematic illustration of a section of a second embodiment of a propulsion device according to the present invention;

FIG. 3 is a schematic illustration of a section of a third embodiment of a propulsion device according to the present invention;

FIG. 4 is a schematic illustration of a section of a fourth embodiment of a propulsion device according to the present invention;

FIG. 5 is a schematic illustration of a section of a fifth embodiment of a propulsion device according to the present invention; and

FIG. 6 is a schematic illustration of a section of a sixth embodiment of a propulsion device according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

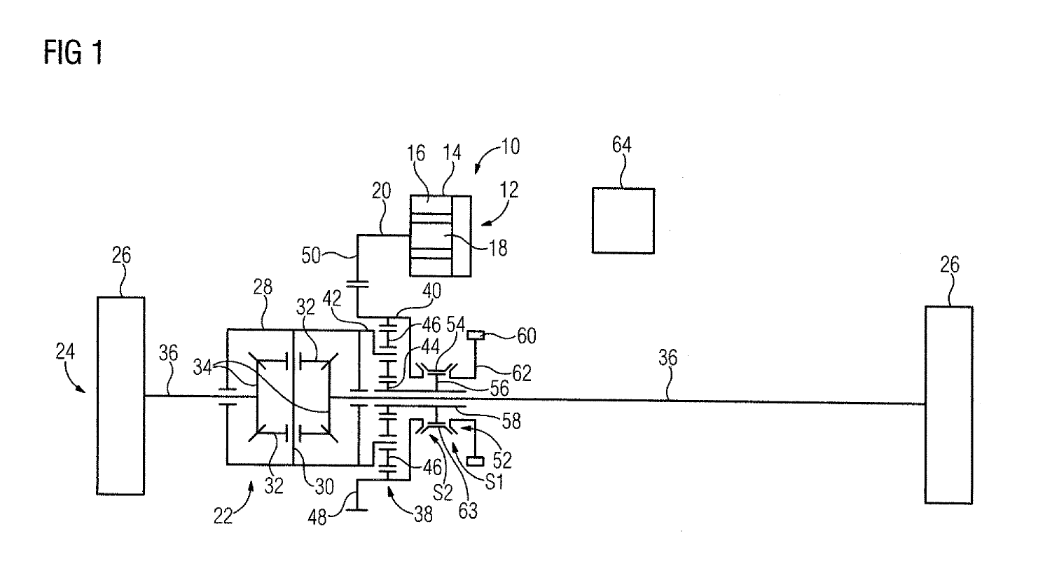

Turning now to the drawing, and in particular to FIG. 1, there is shown a schematic illustration of a first embodiment of a propulsion device according to the present invention, generally designated by reference numeral 10, for use in a vehicle, in particular, an electric vehicle. The propulsion device 10 includes an electric machine 12 shown in FIG. 1 schematically, wherein in particular the arrangement of the electric machine 12 is by way of example in FIG. 1. The electric machine 12 includes a housing 14, in which a stator 16 and a rotor 18 of the electric machine 12 are at least partly accommodated. The stator 16 is fixed to the housing 14, wherein the rotor 18 is able to be rotated about a first axis of rotation relative to the housing 14 and relative to the stator 16. For example the rotor 18 is able to be driven by the stator 16, wherein the rotor 18 is connected to a shaft 20 in a torsion-proof manner. Thus the shaft 20 is able to be rotated about the said first axis of rotation relative to the housing 14, wherein the electric machine 12 can provide torques via the rotor 18 and the shaft 20 to drive the vehicle.

The electric machine 12 is embodied as a traction machine, by means of which the vehicle is able to be driven. To this end the electric machine 12 is able to be operated in a motor mode and thus as a motor or electric motor. In the motor mode the electric machine 12 is supplied with electric energy or electric current respectively, through which the electric machine 12 provides torques to drive the vehicle via the shaft 20.

In order to supply the electric machine 12 with electric current, the propulsion device 10 for example includes at least one electric energy store not shown in FIG. 1, which is embodied as a battery for example. The electric machine 12 is connected via power electronics to the battery for example, so that the electric machine 12 can be supplied with electric current from the battery via the power electronics. Electric energy or electric current can namely be stored by means of the battery, wherein the electric current stored in the battery can be fed via the power electronics to the electric machine 12.

It is further conceivable for the electric machine 12 to be able to be operated in a generator mode. In the generator mode the electric machine 12 functions as a generator and is driven by the moving vehicle and thus by means of kinetic energy of the vehicle. By means of the electric machine 12 at least a part of the kinetic energy of the vehicle is converted in generator mode into electric energy or electric current, wherein this electric current is provided by the electric machine 12. The electric current provided by the electric machine 12 in the generator mode can be fed into the battery for example and stored there and/or fed to at least one electric load, which can be operated by means of the electric energy.

The propulsion device 10 further includes a differential gear 22, which is assigned to an axle of the vehicle labeled overall by the number 24. The axle 24 is for example a rear axle or a front axle and has ground contact elements in the form of wheels 26. While driving along a road the vehicle rolls on the road via the wheels 26 rotating about an axis of rotation. The wheels 26—as is explained in greater detail below—are able to be driven via the differential gear 22 by the electric machine 12 in its motor mode.

The differential gear 22 is also simply referred to as a differential and, when the vehicle is negotiating a curve for example, allows the wheels 26 to rotate at different speeds, so that for example the wheel on the outside of the curve can rotate faster than the wheel on the inside of the curve. This enables disproportionate stresses in the propulsion device 10 or in a drive train of the vehicle to be avoided.

The differential gear 22 includes a cage 28, on which a bolt element 30 is held. Differential gearwheels 32 of the differential gear 22 are supported rotationally on the bolt element 30, wherein the differential gearwheels 32 are embodied as toothed gearwheels and here as bevel gearwheels. The differential gear 22 also includes toothed gearwheels in the form of drive gearwheels 34, which are embodied here as bevel gearwheels. The drive gearwheels 34 engage with the differential gearwheels 32 and are connected in a torsion-proof manner to shafts 36. The shafts 36 are embodied for example as articulated shafts and are coupled to the wheels 26, so that the wheels 26 are able to be driven via the shafts 36 by the electric machine 12.

If the cage 28 is driven by means of the electric machine 12 and during this process is rotated about a second axis of rotation, the differential gearwheels 32 are driven via the bolt element 30 and are rotated during the process about the second axis of rotation, so that once again the drive gearwheels 34 and via these the shafts 36 and thus the wheels 26 are driven about the second axis of rotation. It can be seen from FIG. 1 here that the first axis of rotation, about which the rotor 18 and the shaft 20 are able to be rotated, is at a distance from the second axis of rotation and runs in parallel to the second axis of rotation.

The propulsion device 10 also includes a planetary gear labeled overall by the number 38, which is embodied as a simple planetary gear and includes a first gear element in the form of a hollow gearwheel 40, a second gear element in the form of a planet carrier 42 and a third gear element in the form of a sun gearwheel 44. The planetary gear 38 further includes planet gearwheels 46 different from the gear elements (hollow gearwheel 40, planet carrier 42 and sun gearwheel 44), which are each supported rotatably on the planet carrier 42. The planet carrier 42 is also referred to as a web and is coupled here to the differential gear 22, so that the differential gear 22 is able to be driven via the planetary gear 38, in particular the planet carrier 42, by the electric machine 12 in its motor mode. To this end the planet carrier 42 is connected to the cage 28 in a torsion-proof manner for example. In particular the planet carrier 42 can be embodied in one piece with the cage 28.

The hollow gearwheel 40 has a first set of teeth in the form of inner teeth, wherein the sun gearwheel 44 has a second set of teeth in the form of outer teeth. Furthermore the respective planet gearwheel 46 has a third set of teeth in the form of outer teeth, so that the gear elements are embodied as toothed gearwheels. The planetary gear 38 is thus embodied as a toothed gearwheel gear, wherein the planet gearwheels 46 engage via the respective sets of teeth with the sun gearwheel 44 and the hollow gearwheel 40. In other words the planet gearwheels 46 mesh both with the hollow gearwheel 40 and also with the sun gearwheel 44.

It can be seen in this case from FIG. 1 that the hollow gearwheel 40 (first gear element) is able to be driven by the electric machine 12, so that the planet carrier 42 is able to be driven by the hollow gearwheel 40 and via said gearwheel by the electric machine 12. This means that the differential gear 22, in particular the cage 28, is able to be driven via the planet carrier 42 and the hollow gearwheel 40 by the electric machine 12. To this end the hollow gearwheel 40 is connected in a torsion-proof manner to the toothed gearwheel 48, wherein the toothed gearwheel 48 is embodied for example as a cylindrical gear or as a ring gear. For example the hollow gearwheel 40 is embodied in one piece with the toothed gearwheel 48. In addition a toothed gearwheel 50 is connected to the shaft 20 in a torsion-proof manner, wherein the toothed gearwheel 50 is embodied as a cylindrical gear for example. The toothed gearwheel 50 is also referred to as the pinion or drive pinion and is able to be driven via the shaft 20 by the rotor 18 or by the electric machine 12.

The toothed gearwheel 50 is in engagement with the toothed gearwheel 48 via the respective set of teeth, so that the toothed gearwheel 48 and via said gearwheel the hollow gearwheel 40 are able to be driven via the toothed gearwheel 50 and the shaft 20 by the electric machine 12. The hollow gearwheel 40 thus represents a drive or a drive element of the planetary gear 38, since the torques provided by the electric machine 12 in its motor mode for driving the vehicle via the toothed gearwheels 48 and 50 and thus via the hollow gearwheel 40 are introduced into the planetary gear 38. The web (planet carrier 42) represents a take-off or a take-off element of the planetary gear 38, since the planetary gear 38 provides the torques for driving the vehicle via the web and introduces them into the differential gear 22. In other words the torques for driving the vehicle via the web are derived from the planetary gear 38 and transmitted to the differential gear 22, in particular the cage 28.

The propulsion device 10 further includes a switching device 52 with a first switching element 54 and a second switching element 56. The second switching element 56 is connected to the sun gearwheel 44 in a torsion-proof manner. To this end a shaft 58 is provided, to which both the second switching element 56 and also the sun gearwheel 44 are connected in a torsion-proof manner. For example the sun gearwheel 44 is embodied in one piece with the shaft 58. Thus the second switching element 56 is connected via the shaft 58 in a torsion-proof manner to the sun gearwheel 44.

The first switching element 54 and thus the switching device 52 overall are able to be switched between a first switch position S1 and a second switch position S2. To this end the first switching element 54 is able to be moved relative to the second switching element 56 between the switch positions S1 and S2, wherein the first switching element 54 is able to be moved in an axial direction of the sun gearwheel 44 between the switch positions S1 and S2 and thus translationally.

The propulsion device 10 includes a housing 60 especially shown schematically in FIG. 1, in which the switching device 52 and/or the planetary gear 38 and/or the differential gear 22 are each at least partly accommodated. In this case the gear elements (hollow gearwheel 40, planet carrier 42 and sun gearwheel 44) are able to be rotated relative to the housing 60 about the said second axis of rotation, about which the cage 28 and the shafts 36 are also able to be rotated.

In the first switch position S1 the sun gearwheel 44 is fixed by means of the first switching element 54 on the housing 60, so that the sun gearwheel 44 is secured by means of the switching device 52 against a rotation about the second axis of rotation. In the first switch position S1 the sun gearwheel 44 is supported via the shaft 58, the second switching element 56 and the first switching element 54 on housing 60, so that the sun gearwheel 44 cannot rotate about the second axis of rotation. A switching element 62 fixed to the housing 60 is provided for this purpose for example, with which the first switching element 54 interacts in the first switch position S1. As a result of this interaction the sun gearwheel 44 is fixed to the housing 60 and cannot rotate about the second axis of rotation relative to housing 60.

In the second switch position the sun gearwheel 44 is connected via the shaft 58, the second switching element 56 and the first switching element 54 in a torsion-proof manner to the hollow gearwheel 40, so that the hollow gearwheel 40 and the sun gearwheel 44—when the hollow gearwheel 40 is driven via the toothed gearwheels 48 and 50 by the electric machine 12—orbit as a block and thus rotate together about the second axis of rotation relative to the housing 60.

For example a fourth switching element 63 is connected in a torsion-proof manner to the hollow gearwheel 40, wherein the first switching element 54 in the second switch position S2 interacts with the fourth switching element 63, so that through this the sun gearwheel 44 is connected in a torsion-proof manner via the shaft 58, the second switching element 56, the first switching element 54 and the fourth switching element 63 to the hollow gearwheel 40.

Overall it can be seen that the sun gearwheel 44, in the first switch position S1, is coupled to the housing 60 and in the second switch position S2 to the hollow gearwheel 40 in a torsion-proof manner. It is further conceivable that the first switching element 54 is able to be moved into neutral position, in which the sun gearwheel 44 is decoupled both from the housing 60 and also from the hollow gearwheel 40.

In the first switch position S1 the planetary gear 38 has a first gear ratio i₁, which essentially amounts to at least 1.5. In the second switch position S2 the planetary gear 38 advantageously has a second gear ratio i₂, which essentially at least amounts to 1. Thus the first switch position S1 is a slow gear or a starting ratio, in which an especially high initial acceleration can be realized. This enables the vehicle to be accelerated especially strongly by means of the electric machine 12. The second switch position S2 is a fast gear, by means of which an especially high top speed of the vehicle can be realized by means of the electric machine 12.

The propulsion device 10 advantageously includes an actuator 64 especially shown schematically in FIG. 1 and coupled to the switching device 52, in particular to the first switching element 54, in a way not shown in any greater detail, by means of which the switching element 54 is able to be switched or moved. The actuator 64 is embodied for example as an electromechanical actuator or hydraulic actuator, in particular an electrohydraulic actuator, or electromagnetic actuator, so that the first switching element 54 can be switched by means of the actuator 64 automatically or in an automated manner or semi-automatically or in a semi-automated manner.

As an especially simple solution the switching device 52 operates purely by making a form fit while interrupting the flow of power during the changing of switching stages S1 and S2, wherein this change is also called a gear change. Thus, provision is advantageously made for the first switching element 54 to interact in the first switch position S1 by a form fit with the third switching element 62 and in the second switch position S2 to interact by a form fit with the fourth switching element 63, so that a form-fit coupling of the sun gearwheels 44 with the housing 60 or the hollow gearwheel 40 respectively is provided. To this end the switching device 52 is embodied as a claw switch for example, so that the first switching element 54 is embodied as the switching claw. The switching claw in each case has teeth for example, wherein die switching elements 62 and 63 are embodied as respective sets of teeth. Through this the teeth act in the respective switch positions S1 and S2 in a form fit with one another.

In a comparatively more complex version the switch positions S1 and S2, also referred to as gears, can be changed without interrupting the tractive power. This means for example that the first switching element 54 in the first switch position S1 interacts by a friction fit with the third switching element 62 and in the second switch position S2 by a friction fit with the fourth switching element 63, so that then the sun gearwheel 44 is coupled in each case by a friction fit with the housing 60 or with the hollow gearwheel 40 respectively.

The design of the actuator 64 is oriented for example to the respective design of other actuators used in the propulsion device 10, so that these actuators use the same operating principle. The switching element 54 is a separation element, which is used for coupling and decoupling or separating the sun gearwheel 44. For this separating element for example an axial form fit in particular in the form of a claw coupling similar to a synchronizing unit, or a friction fit, in particular with flat or cone-shaped friction surfaces, is conceivable.

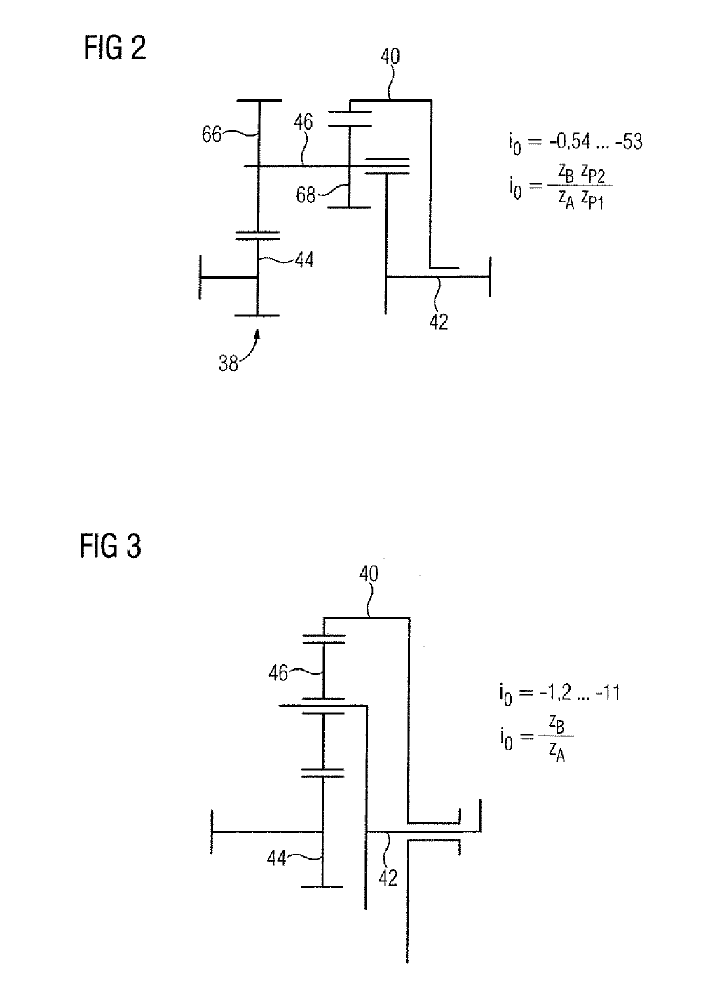

Through the first switch position S1 a low speed range is able to be realized, in which the vehicle is moved or driven respectively, i.e. can be driven by the electric machine 12. Through the second switching stage S2 for example a so-called high speed range is able to be realized, in which the vehicle can be driven, wherein the high speed range is higher than the low speed range. Advantageously, provision is also made for the planetary gear 38 to have a stationary gear ratio i₀, which lies for example in a range from −4 inclusive to −1.5 inclusive. Through the integration of the planetary gear 38 an additional gear ratio is realized for the low speed range, for example an effective gear ratio of iᵢ=1−i₀⁻¹, with retention of the direction of rotation. Advantageously, provision is made for a gear step when switching from a low speed range to a high speed range, wherein this gear step lies in a range from 1.3 inclusive to 1.6 inclusive, which has been shown to be advantageous for an electric vehicle, in particular a Battery-Electric Vehicle (BEV). For a Hybrid Vehicle (HEV) a greater gear step can be advantageous, wherein the limits of the concept are able to be expanded by using a kinematic equivalent planet set. This means that FIG. 1 shows a first form of embodiment of the propulsion device 10, wherein FIGS. 2 to 7 illustrate further possible forms of embodiment of the propulsion device 10.

In the low speed range, i.e. in the first switch position S1, the sun gearwheel 44 is firmly held via the switching device 52, in particular in a form fit, wherein the drive takes place via the hollow gearwheel 40 with a ratio retaining the direction of rotation into the slow range. In the high speed range, i.e. in the second switch position S2, the sun gearwheel 44 is connected with the aid of the switching device 52, in particular in a form fit, to the hollow gearwheel 40, so that the planetary gear 38 or the planet set then orbits as a block.

Thus overall a two-gear stage is realized. For an especially simple way of realizing the two-gear stage the integration of a rotational speed sensor, in particular on housing 60, is advantageous, in order for example either for the simple variant with tractive power interruption, to synchronize by rapid electric regulation or in order with the more complex variant capable of load switching, to enable the slip behavior of the friction-fit power-guiding components to be better regulated.

It is further advantageous that both the variant with and also the variant without tractive power interruption are able to be designed with just one active element as actuator 64. It is further conceivable to dispose the differential gear 22 and the switching device 52 differently along the axis 24 in the vehicle, which in particular involves the axial location of the differential ring gearwheel, i.e. the toothed gearwheel 48.

It might also be additionally possible to integrate a parking brake with at least one parking brake element into the propulsion device 10 and to actuate the parking brake element by means of the same actuator 64 as the first switching element 54, i.e. to move it. Then a primary actuator of the parking brake can be dispensed with, wherein for reasons of functional safety only a significantly more simple secondary actuator is still provided for the parking brake element.

Also conceivable are other arrangements of the switching device 52, in particular as a coaxial construction element directly on the electric machine 12 or as a parallel arrangement based on cylindrical gears. By means of the propulsion device 10 shown in FIG. 1 the installation space requirement can be kept especially low however. The advantage of the propulsion device 10 in accordance with FIG. 1 is that the two-gear stage as a constructional unit with the differential gear 22 provides the opportunity for compressing functions, since the differential gear 22 and the switching stage or switching device 52 respectively can form one unit. In addition it is possible in an especially simple manner to actuate the parking brake element by means of the actuator 64, by means of which the first switching element 54 is also actuated.

FIG. 2 shows a schematic illustration of a second embodiment of a propulsion device 10 according to the present invention. Parts corresponding with those in FIG. 1 are denoted by identical reference numerals. The description below will center on the differences between the embodiments. In this embodiment, provision is made for planetary gear 38 of the planetary gear 38, which has a stationary gear ratio i₀ in an advantageous range of i₀=−0.54 . . . −53, with

$${i}_{0} = \frac{{z}_{B} {z}_{P 2}}{{z}_{A} {z}_{P 1 }}$$

wherein z_{A} designates the number of teeth of the hollow gearwheel 40, and z_{B} designates the number of teeth of the hollow gearwheel 40. In addition, the respective planet gearwheel 46 is embodied as a double planet gearwheel, so that the planet gearwheel 46 has two planet gearwheel elements 66 and 68, which are connected to one another in a torsion-proof manner. In this case z_{P1} designates the number of teeth of the planet gearwheel element 66 and z_{P2} number of teeth of the planet gearwheel element 68. The planet gearwheel element 66 is in engagement with the hollow gearwheel 40 and the planet gearwheel element 68 is in engagement with the hollow gearwheel 40.

FIG. 3 shows a schematic illustration of a third embodiment of a propulsion device 10 according to the present invention. In this embodiment, the stationary gear ratio i₀ ranges according to i₀=−1.2 . . . −11, with

$${i}_{0} = \frac{{z}_{B}}{{z}_{A}}$$

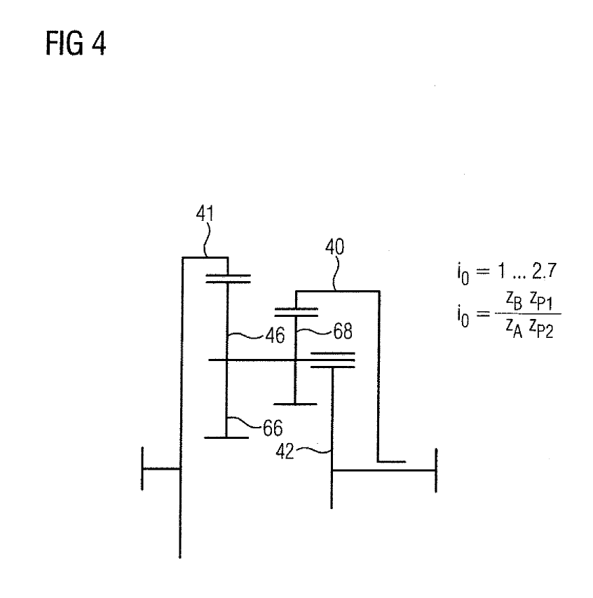

FIG. 4 shows a schematic illustration of a fourth embodiment of a propulsion device 10 according to the present invention. In this embodiment, a second hollow gearwheel 41 is provided as the third gear element instead of a sun gearwheel in addition to hollow gearwheel 40. The stationary gear ratio i₀ ranges according to i₀=1 . . . 2.7, with

$${i}_{0} = \frac{{z}_{B} {z}_{P 1}}{{z}_{A} {z}_{P 2 }}$$

wherein z_{B} designates the number of teeth of the hollow gearwheel 40 and z_{A} the number of teeth of the hollow gearwheel 41.

FIG. 5 shows a schematic illustration of a firth embodiment of a propulsion device 10 according to the present invention. In this embodiment, a further planet gearwheel 70 is provided in addition to planet gearwheel 46, wherein the planet gearwheels 46 and 70 are not connected to one another in a torsion-proof manner, but engage with one another via their respective teeth, so that the planet gearwheels 46 and 70 mesh with one another and can be rotatable relative to one another. In this case the planet gearwheel 46 is in engagement with the sun gearwheel 44 as well as being in engagement with the planet gearwheel 70, which is in engagement with the planet gearwheel 46 and in engagement with the hollow gearwheel 40. The stationary gear ratio i₀ ranges according to i₀=1.2 . . . −17.6, with

$${i}_{0} = \frac{{z}_{B}}{{z}_{A}}$$

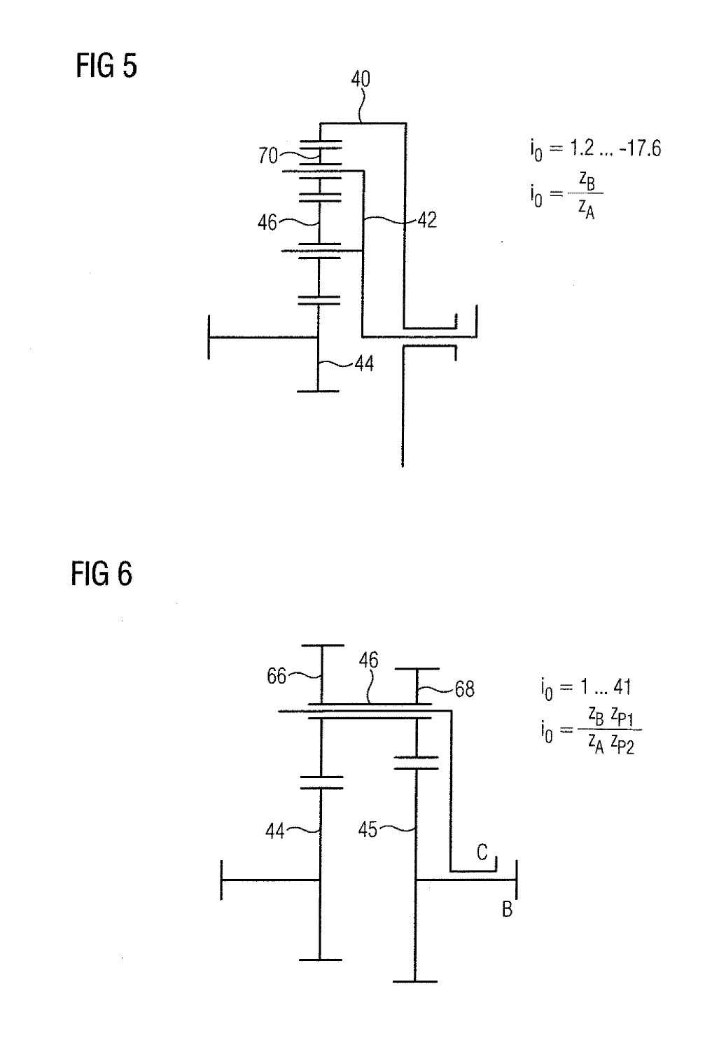

FIG. 6 shows a schematic illustration of a sixth embodiment of a propulsion device 10 according to the present invention. In this embodiment, both the third gear element and also the first gear element are embodied as sun gearwheels 44 and 45, wherein the planet gearwheel 46 is embodied as a double planet gearwheel. In this case, the planet gearwheel elements 66 and 68 are connected to one another in a torsion-proof manner, wherein the planet gearwheel element 66 is in engagement with the sun gearwheel 44 and the planet gearwheel element 68 is in engagement with the sun gearwheel 45. The stationary gear ratio i₀ ranges according to i₀=1.2 . . . 41, with

$${i}_{0} = \frac{{z}_{B} {z}_{P 1}}{{z}_{A} {z}_{P 2 }}$$

wherein z_{B} designates the number of teeth of the sun gearwheel 45 and z_{A} the number of teeth of the sun gearwheel 44.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A propulsion device for a vehicle, comprising:
an electric machine;
a differential gear driven by the electric machine and operatively connected to an axle on the vehicle, with ground contact elements of the axle being driven by the electric machine via the differential gear;
a planetary gear via which the differential gear is driven by the electric machine, said planetary gear comprising at least three gear elements that are rotatable about an axis of rotation, with one of the at least three gear elements being configured as a planet carrier, and at least one planet gearwheel which is different from the at least three gear elements, said planet gearwheel being rotatably supported on one of the at least three gear elements and in engagement with the other ones of the at least three gear elements via respective sets of teeth, a first one of the at least three gear elements being driven by the electric machine, and a second one of the at least three gear elements being driven by the electric machine via the first of the at least three gear elements and coupled to the differential gear;
a switching device including at least one switching element and switchable between a first switch position, in which a third one of the at least three gear elements is secured against a rotation about the axis of rotation, and at least one second switch position in which the third one of the at least three gear elements is connected by the switching device to the first one of the at least three gear elements in a torsion-proof manner;
an actuator configured to move the at least one switching element of the switching device between the first and second switch positions; and
a parking brake including at least one parking brake element, said parking brake being movable by the actuator between a park position, in which the vehicle is prevented from rolling away, and at least one release position.

2. The propulsion device of claim 1, wherein the first one of the at least three gear elements is a hollow gearwheel, the second one of the at least three gear elements is a planet carrier, and the third one of the at least three gear elements is a sun gearwheel of the planetary gear.

3. The propulsion device of claim 1, wherein the actuator is an electromechanical actuator, a hydraulic actuator, an electro-hydraulic actuator, or an electromagnetic actuator.

4. The propulsion device of claim 1, wherein the planetary gear has a stationary gear ratio ranging from 1.5 to 4.

5. The propulsion device of claim 1, wherein the planetary gear in the second switch position has a gear ratio which is smaller than a gear ratio in the first switch position.

6. The propulsion device of claim 5, wherein the planetary gear has a gear step of at least 1.3, when the switching device switches from the first switch position to the second switch position.

7. The propulsion device of claim 6, wherein the gear step ranges from 1.3 to 1.6.

8. The propulsion device of claim 1, further comprising at least one rotational speed sensor configured to detect a rotational speed of one of the at least three gear elements.

9. The propulsion device of claim 1, wherein the third one of the at least three gear elements is secured via the switching device in the first switch position by a form fit against a rotation about the axis of rotation and is connected in the second switch position by a form fit to the first one of the at least three gear elements in a torsion-proof manner.

10. The propulsion device of claim 1, wherein the third one of the at least three gear elements is secured via the switching device in the first switch position by a friction fit against a rotation about the axis of rotation and connected in the second switch position by a friction fit to the first one of the at least three gear elements in a torsion-proof manner.

11. A motor vehicle, comprising:
at least one electric machine for driving the vehicle; and
a propulsion device comprising a differential gear driven by the electric machine and operatively connected to an axle on the vehicle, with ground contact elements of the axle being driven by the electric machine via the differential gear, a planetary gear via which the differential gear is driven by the electric machine, said planetary gear comprising at least three gear elements that are rotatable about an axis of rotation, with one of the at least three gear elements being configured as a planet carrier, and at least one planet gearwheel which is different from the at least three gear elements, said planet gearwheel being rotatably supported on one of the at least three gear elements and in engagement with the other ones of the at least three gear elements via respective sets of teeth, a first one of the at least three gear elements being driven by the electric machine, and a second one of the at least three gear elements being driven by the electric machine via the first of the at least three gear elements and coupled to the differential gear, a switching device including at least one switching element and switchable between a first switch position, in which a third one of the at least three gear elements is secured against a rotation about the axis of rotation, and at least one second switch position in which the third one of the at least three gear elements is connected by the switching device to the first one of the at least three gear elements in a torsion-proof manner, an actuator configured to move the at least one switching element of the switching device between the first and second switch positions, and a parking brake including at least one parking brake element, said parking brake being movable by the actuator between a park position, in which the vehicle is prevented from rolling away, and at least one release position.

12. The motor vehicle of claim 11, wherein the first one of the at least three gear elements is a hollow gearwheel, the second one of the at least three gear elements is a planet carrier, and the third one of the at least three gear elements is a sun gearwheel of the planetary gear.

13. The motor vehicle of claim 11, wherein the actuator is an electromechanical actuator, a hydraulic actuator, an electro-hydraulic actuator, or an electromagnetic actuator.

14. The motor vehicle of claim 11, wherein the planetary gear has a stationary gear ratio ranging from 1.5 to 4.

15. The motor vehicle of claim 11, wherein the planetary gear in the second switch position has a gear ratio which is smaller than a gear ratio in the first switch position.

16. The motor vehicle of claim 15, wherein the planetary gear has a gear step of at least 1.3, when the switching device switches from the first switch position to the second switch position.

17. The motor vehicle of claim 16, wherein the gear step ranges from 1.3 to 1.6.

18. The motor vehicle of claim 11, wherein the propulsion device includes at least one rotational speed sensor configured to detect a rotational speed of one of the at least three gear elements.

19. The motor vehicle of claim 11, wherein the third one of the at least three gear elements is secured via the switching device in the first switch position by a form fit against a rotation about the axis of rotation and is connected in the second switch position by a form fit to the first one of the at least three gear elements in a torsion-proof manner.

20. The motor vehicle of claim 11, wherein the third one of the at least three gear elements is secured via the switching device in the first switch position by a friction fit against a rotation about the axis of rotation and connected in the second switch position by a friction fit to the first one of the at least three gear elements in a torsion-proof manner.
